(19) United States
(12) Patent Application Publication
(10) Pub. No.: US 2003/0224217 A1
(43) Pub. Date: Dec. 4, 2003

(54) Metal nitride formation

(75) Inventors: Jeong Soo Byun, Cupertino, CA (US); Alfred W. Mak, Union City, CA (US); Hui Zhang, Santa Clara, CA (US); Hyungsuk Alexander Yoon, Santa Clara, CA (US); Avgerinos V. Gelatos, Redwood City, CA (US); Robert L. Jackson, San Jose, CA (US); Ming Xi, Palo Alto, CA (US); Randhir P.S. Thakur, San Jose, CA (US)

Correspondence Address: PATENT COUNSEL, APPLIED MATERIALS, INC., Legal Affairs Department, P.O. BOX 450A, Santa Clara, CA, 95052, US

(73) Assignee: Applied Materials, Inc.

(21) Appl. No.: 10/278,179

(22) Filed: Oct. 21, 2002

Related U.S. Application Data
(60) Provisional application No. 60/384,641, filed on May 31, 2002.

(51) Int. Cl. B32B 18/00

(52) U.S. Cl. 428/698; 428/469

(57) ABSTRACT

A process for treating refractory metal-boron layers deposited by atomic layer deposition resulting in the formation of a ternary amorphous refractory metal-nitrogen-boron film is disclosed. The resulting ternary film remains amorphous following thermal annealing at temperatures up to 800° C. The ternary films are formed following thermal annealing in a reactive nitrogen-containing gas. Subsequent processing does not disrupt the amorphous character of the ternary film. arrangement where a blended solution is supplied to a remote point of use.

This application claims priority from U.S. Provisional Application Serial No. 60/384,641 filed May 31, 2002 entitled, “Metal Nitride Formation”. The foregoing patent application, which is assigned to the assignee of the present application, is incorporated herein by reference in its entirety.

### BACKGROUND OF THE INVENTION

Refractory metal-based binary and ternary layers have been investigated as promising candidates for use in barrier layers in the fabrication of interconnect structures in integrated circuits. Barrier layers are used to prevent diffusion between the conductive (metallized) and dielectric layers of interconnect metallization structures, as such diffusion would degrade the planned and controlled electrical access (e.g., via holes) between successive conductive layers. Barrier layers are preferably highly amorphous as grain boundaries in polycrystalline (i.e., non-amorphous) barrier films provide pathways for diffusion, such as diffusion of copper in copper metallization structures. A major goal in the formation of refractory metal-based binary and ternary films is, therefore, maintenance of the films' amorphous character.

Because barrier films may be deposited as an intermediary step in integrated circuit fabrication and because subsequent processing may involve temperatures of up to 800° C., it is important that the barrier films retain their amorphous character following exposure to high temperatures. It is also desirable that barrier films possess low resistivity, as net line resistance following complete line encapsulation should be minimized. In addition, increasing aspect ratios of interconnect structures require barrier layers with good conformal step coverage. Finally, it is also important to minimize microscopic reactions between the barrier layer and the adjoining layers.

Refractory metal-based binary and ternary layers have also been investigated for use in bottom electrode applications of metal-insulator-metal (MIM) structured capacitors in dynamic random access memory (DRAM) fabrication. One important consideration for choosing a material for a bottom electrode is that it be inert when exposed to oxygen during the high temperature deposition of the dielectric layer and in the post-deposition annealing in an oxygen ambient, as such conditions are necessary to achieve a high dielectric constant and low leakage current in the capacitor structure. In addition to this, it is important that the material chosen allow for uniform film coverage on highly aggressive geometries.

Metal nitride films deposited by conventional methods such as chemical vapor deposition recrystallize at annealing temperatures above 500° C. with thermal desorption of nitrogen, decreasing the value of such films as barrier layers. Yet, atomic layer deposition of tungsten nitride utilizing a gas phase reaction between WF₆ an NH₃ results in a film with a resistivity of about 4500 milli-ohms, thereby diminishing the value of such films for use as a capacitor electrode.

As an example of refractory metal deposition, tungsten (W) films have also been formed by the vapor phase reaction of WF6 and B2H6 (referred to herein as ALD-W films). It should be understood that atomic layer deposition (ALD) films may be formed using refractory metals other than tungsten, such as tantalum, molybdenum, titanium, zirconium, hafnium, cobalt, ruthenium, platinum, iridium and palladium. ALD-W films are very good candidates for use as barriers in copper metallization structures and as bottom electrodes in MIM structured capacitors. Nevertheless, certain problems are presented by ALD-W films. Specifically, compounds having boron and oxygen only, such as boron oxides, and metal compounds having B₄O₇, such as CaB₄O₇ and NaB₄O₇, i.e., borates, are present on the surface of ALD-W films following film deposition. Furthermore, desorption and outgassing of unbound atomic components of the ALD-W film can result in formation of contaminants and undesirable changes in properties of the device.

Therefore, a need exists in the art for formation of a reliable barrier layer having the properties of amorphous phase following exposure to high temperatures and low resistivity. There is a further need for a metal film for use as a bottom electrode in MIM capacitors which: (1) is inert to oxidation during exposure to high temperatures; (2) provides highly conformal step coverage on highly aggressive geometries; and (3) has low resistivity.

### SUMMARY OF THE INVENTION

The present invention provides a process for the treatment of ALD films, or layers, such that the ALD film retains its amorphous character but is modified to eliminate pre-existing surface oxides and to prevent desorption and outgassing of unbound atomic species during high temperature annealing.

In one embodiment of the process, a refractory metal-boron layer is annealed in a nitrogen-containing environment at a temperature of at least 400° C., where the resulting amorphous film comprises a single regime containing metal-nitrogen bonds and metal-boron bonds. In an alternative embodiment of the present invention, a refractory metal-boron layer is annealed in nitrogen-containing ambient at temperatures >600° C. The resulting amorphous film comprises two regimes: (1) a surface layer which is a nitrogen-rich ternary phase containing large amounts of boron-nitrogen bonds and metal-nitrogen bonds as well as smaller amounts of metal-boron and metal-nitrogen bonds; and (2) a non-surface nitrogen-depleted ternary phase containing primarily metal-boron and metal-nitrogen bonds. In a preferred embodiment, the refractory metal is tungsten.

The layers resulting from the nitrogen-containing annealing treatments are compatible with integrated circuit fabrication processes. In one integrated circuit fabrication process, the treated ALD-metal film is used as a barrier layer in copper (Cu) metallization structures. In another integrated circuit fabrication process, an ammonia ambient annealed ALD-metal film is used as a bottom electrode for MIM structured capacitor DRAM.

### BRIEF DESCRIPTION OF THE DRAWINGS

The teachings of the present invention can be readily understood by considering the following detailed description in conjunction with the accompanying drawings, in which:

FIG. 1 depicts a schematic illustration of an apparatus that can be used for the practice of the thermal annealing in reactive nitrogen-containing gas embodiment described herein;

FIGS. 2a-2d depict schematic cross-sectional views of an integrated circuit structure at different stages of integrated circuit fabrication incorporating an ammonia ambient annealed ALD-W film;

FIGS. 3a-3g depict schematic cross-sectional views of an integrated circuit during different stages of MIM capacitor fabrication incorporating the process of the present invention;

FIG. 4a illustrates an x-ray diffraction pattern of an ALD-W film prior to treatment using the process of the present invention;

FIG. 4b illustrates an x-ray diffraction pattern of an ALD-W film following treatment according to the process of the present invention;

FIG. 5 illustrates a transmission electron microscopy (TEM) image of a cross section of a substrate-glue layer-ALD-W film structure following treatment in accordance with the present invention;

FIG. 6 shows sheet resistance variation of ALD-W versus W—B—N films as a function of annealing temperature;

FIGS. 7a and 7b show the binding energy shifts of tungsten (W(4f)), and boron (B(1s)), respectively, of an untreated, unannealed ALD-W film following argon sputtering with spectra taken at 5 second intervals from 0 seconds to 20 seconds;

FIGS. 8a-8c show the binding energy shifts of tungsten (W(4f)), nitrogen N(1s) and boron (B(1s)), respectively, of the ALD-W film following annealing at 500° C. in ammonia ambient for 60 seconds with XPS spectra taken at 5 second intervals of argon sputtering from 0 seconds to 25 seconds;

FIGS. 9a-9c show the binding energy shifts of tungsten (W(4f)), nitrogen N(1s) and boron (B(1s)), respectively, of the ALD-W film following annealing at 700° C. in ammonia ambient for 60 seconds with XPS spectra taken at 10 second intervals from 0 seconds to 60 seconds; and

FIG. 10a illustrates the distribution of atoms of an ALD-W film compared to the distribution of atoms of an ALD-W film following ammonia ambient annealing at 700° C. as a function of sputtering time; and FIG. 10b shows a comparison of the nitrogen content as a function of sputtering time between the ALD-W film annealed at 500° C. in ammonia and ALD-W film annealed at 700° C. in ammonia.

### DETAILED DESCRIPTION OF THE INVENTION

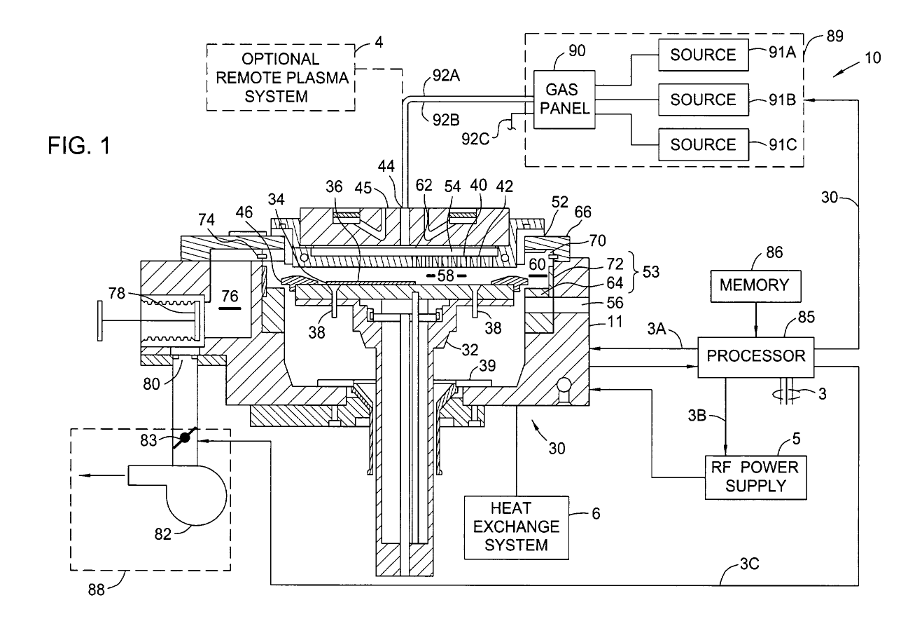

FIG. 1 shows a schematic representation of a wafer processing system 10 that can be used to perform the nitrogen-containing gas ambient thermal annealing process described herein. Referring to FIG. 1, the CVD system 10 includes reactor chamber 30, which receives gases from a gas delivery system 89 via gas lines 92A-C (other lines may be present but not shown). A vacuum system 88 is used to maintain a specified pressure in the chamber and removes gaseous byproducts and spent gases from the chamber. An RF power supply 5 provides radio-frequency power to the chamber for plasma-enhanced processes. A liquid heat exchange system 6 employs a liquid heat exchange medium, such as water or a water-glycol mixture, to remove heat from the reactor chamber and maintain certain portions of the chamber at a suitable temperature for stable process temperatures. A processor 85 controls the operation of the chamber and sub-systems according to instructions stored in memory 86 via control lines 3, 3A-D (only some of which are shown).

Processor 85 executes system control software, which is a computer program stored in a memory 86 coupled to processor 85. Preferably, memory 86 may be a hard disk drive, but memory 86 may be other kinds of memory. In addition to a hard disk drive (e.g., memory 86), CVD apparatus 10 in a preferred embodiment includes a floppy disk drive and a card rack. Processor 85 operates under the control of the system control software, which includes sets of instructions that dictate the timing, mixture of gases, gas flow, chamber pressure, chamber temperature, RF power levels, heater pedestal position, heater temperature and other parameters of a particular process. Other computer programs such as those stored on other memory including, for example, a floppy disk or other computer program product inserted in a disk drive or other appropriate drive, may also be used to operate processor 85.

Gas delivery system 89 includes gas supply panel 90 and gas or liquid or solid sources 91A-C (additional sources may be added if desired), containing gases, liquids, or solids that vary depending on the desired processes used for a particular application. Generally, the supply line for each of the process gases includes a shut-off valve (not shown) that can be used to automatically or manually shut off the flow of process gas, as well as a mass flow controller (not shown) that measures the flow of gas or liquid through each of the supply lines. The rate at which the process and carrier gases and/or other dopant or reactant sources are supplied to reaction chamber 30 also is controlled by temperature-based liquid or gas mass flow controllers (MFCs) (not shown) and/or by valves (not shown). Of course, it is recognized that other compounds may be used as deposition and clean sources. In alternative embodiments, the rate at which the process and carrier gases are supplied to reaction chamber 30 also may be controlled by a pressure-based fixed or variable aperture. When toxic gases are used in the process, the several shut-off valves may be positioned on each gas supply line in conventional configurations. Gas supply panel 90 has a mixing system which receives the deposition process and carrier gases (or vaporized liquids) from the sources 91A-C for mixing and sending to a central gas inlet 44 in a gas feed cover plate 45 via supply lines 92A-C. The mixing system, the input manifold to the mixing system, and the output manifold from the mixing system to the central inlet 44 may be made of nickel or of a material such as alumina plated with nickel.

When a liquid source is used, there are many different ways to introduce a source gas using a liquid source in a CVD system. One way is to confine and heat the liquid in an ampule so that the vapor pressure provides a stable flow of the vaporized source that is sufficient for the deposition process. The ampule is typically not filled with liquid, but has a “head space” over the liquid, acting as a vapor reservoir. Because the vapor pressure depends on the temperature of the liquid, precise temperature control of the liquid source is important. A mass flow controller (MFC) may be used to control the output of the source gas to the chamber.

Another way to introduce a source gas using a liquid source is to bubble a carrier gas, such as helium, through the liquid. The carrier gas provides a head pressure over the liquid and carries the vapor downstream to the chamber. The liquid may be temperature-controlled to maintain a constant vapor partial pressure. It is desirable to heat the liquid above the highest expected ambient temperature of the environment in which the ampule is located, so that a constant temperature may be maintained using only a heater. As discussed above, a MFC may be used to control the carrier gas/vapor mixture to the chamber. As an alternative to using an MFC, which operates on a principle of thermal mass transfer and is typically calibrated to a particular gas, a pressure-regulating device may be used to control the output of the source gas to the chamber. One such device is an aperture, or orifice, that acts to throttle the gas flow and hence allows a higher pressure to be maintained on one side of the orifice than the other. By controlling the chamber (output) pressure, bubbler gas flow, and liquid temperature, a fixed orifice may maintain a constant pressure over the liquid and hence a constant vapor concentration in the source gas. As a variation of this technique, an additional gas source, such as argon, that provides relatively small volumes of gas to the head space over the liquid may be utilized to maintain the head pressure despite other changes, such as the temperature of the liquid, for example. This pressurizing gas may be used with sources incorporating either an MFC or orifice on the source output.

In other embodiments, the gas mixing system may include a liquid injection system to provide a source gas from a vaporized liquid source into the chamber. A liquid injection system vaporizes a measured quantity of liquid into a carrier gas stream. Because this type of system does not depend on the vapor pressure of the liquid for operation, the liquid does not need to be heated. A liquid injection system is preferred in some instances as it provides greater control of the volume of reactant liquid introduced into the gas mixing system compared to bubbler-type sources.

Liquid heat exchange system 6 delivers liquid to various components of chamber 30 to maintain these components at a suitable temperature during the high temperature processing. This system 6 acts to decrease the temperature of some of these chamber components in order to minimize undesired deposition onto these components due to the high temperature processes. As seen in FIG. 1A, heat exchange passages 79 within gas feed cover plate 45 allow the heat exchange liquid to circulate through gas feed cover plate 45, thus maintaining the temperature of gas feed cover plate 45 and adjacent components. Liquid heat exchange system 6 includes connections (not shown) that supply the liquid (such as water) through a heat exchange liquid manifold (not shown) for delivering the liquid to the gas distribution system including faceplate 40 (discussed below). A waterflow detector detects the waterflow from a heat exchanger (not shown) to the enclosure assembly.

A resistively-heated pedestal 32 supports wafer 36 in a wafer pocket 34. Pedestal 32 may be moved vertically between processing positions and a lower loading position using a self-adjusting lift mechanism. Lift pins 38 are slidable within pedestal 32 but are kept from falling out by conical heads on their upper ends. The lower ends of lift pins 38 may be engaged with a vertically movable lifting ring 39 and thus can be lifted above the pedestal's surface. With pedestal 32 in the lower loading position (slightly lower than an insertion/removal opening 56), a robot blade (not shown) in cooperation with the lift pins and the lifting ring transfers wafer 36 in and out of chamber 30 through insertion/removal opening 56, which can be vacuum-sealed to prevent the flow of gas into or out of the chamber through insertion/removal opening 56. Lift pins 38 raise an inserted wafer (not shown) off the robot blade, and then the pedestal rises to raise the wafer off the lift pins onto the wafer pocket on the upper surface of the pedestal.

Through the use of the self-aligning lift mechanism, pedestal 32 then further raises wafer 36 into the processing position, which is in close proximity to a gas distribution faceplate (hereinafter “showerhead”) 40. The process gas is injected into reactor 30 through central gas inlet 44 in gas-feed cover plate 45 to a first disk-shaped space 48 and from thence through passageways 57 in a baffle plate (or gas blocker plate) 62 to a second disk-shaped space 54 to showerhead 40. Showerhead 40 includes a large number of holes or passageways 42 for jetting the process gas into process zone 58.

The process gas jets from holes 42 in showerhead 40 into processing zone 58 between the showerhead and the pedestal, so as to react at the surface of wafer 36. The process gas byproducts then flow radially outward across the edge of wafer 36 and a flow restrictor ring 46 (described in more detail below), which is disposed on the upper periphery of pedestal 32 when pedestal 32 is in the processing position. Next, the process gas flows through choke aperture formed between the bottom of annular isolator 52 and the top of chamber wall liner assembly 53 into pumping channel 60. Upon entering pumping channel 60, the exhaust gas is routed around the perimeter of the process chamber, to be evacuated by the vacuum pump 82. Pumping channel 60 is connected through exhaust aperture 74 to pumping plenum 76. Exhaust aperture 74 restricts the flow between the pumping channel and the pumping plenum. Valve 78 gates the exhaust through exhaust vent 80 to vacuum pump 82. Throttle valve 83 is controlled by the system controller (not shown in this view) according to a pressure control program stored in memory (not shown) which compares a measured signal from a pressure sensor (not shown), such as a manometer, against a desired value which is stored in memory or generated according to the control program.

The sides of annular pumping channel 60 generally are defined by ceramic ring 64, a chamber lid liner 70, a chamber wall liner 72, and an isolator 52. Chamber lid liner 70 is placed on the side of pumping channel 60 facing a lid rim 66 and conforms to the shape of the lid. Chamber wall liner 72 is placed on the side of pumping channel 60 facing main chamber body 11. Both liners are preferably made of a metal, such as aluminum, and may be bead blasted to increase the adhesion of any film deposited thereon. Lid and wall chamber liners 70 and 72 are sized as a set. Chamber lid liner 70 is detachably fixed to lid rim 66 by a plurality of pins that also electrically connect the lid liner to the lid rim. However, chamber wall liner 72 is supported on a ledge formed on the outer top of ceramic ring 64 and is precisely formed to have a diameter such that a radial gap is formed between chamber wall liner 72 and main chamber body 11, and so that an axial gap is formed between the lid and chamber liners.

Choke aperture 50 has a substantially smaller width than the depth of the processing zone 58 between showerhead 40 and wafer 36, and is substantially smaller than the minimum lateral dimensions of circumferential pumping channel 60, for example by at least a factor of five. The width of the choke aperture is made small enough, and its length long enough, so as to create sufficient aerodynamic resistance at the operating pressure and gas flow so that the pressure drop across choke aperture is substantially larger than any pressure drops across the radius of the wafer or around the circumference of the annular pumping channel. The constricted exhaust aperture performs a function similar to that of the choke aperture by creating an aerodynamic impedance, creating a nearly uniform pressure around circumferential pumping channel 60.

Motors and optical sensors (not shown) are used to move and determine the position of movable mechanical assemblies such as throttle valve 83 and pedestal 32. Bellows (not shown) attached to the bottom of pedestal 32 and chamber body 11 form a movable gas-tight seal around the pedestal. The pedestal lift system, motors, gate valve, plasma system, including an optional remote plasma system 4 (which may be used to provide chamber clean capability using a remote plasma formed using, for example, a microwave source), and other system components are controlled by processor 85 over control lines 3 and 3A-D, of which only some are shown.

Also seen is pedestal 32, liners 70 and 72, isolator 52, ring 64, and pumping channel 60. This figure shows the flow of processing gas out of nozzles 42 in showerhead 40 toward wafer 36, then radially outward flow over wafer 36. Thereafter, the gas flow is deflected upwardly over the top of restrictor ring 46 into pumping channel 60. In pumping channel 60, the gas flows along circumferential path 86 towards the vacuum pump.

Pumping channel 60 and its components are designed to minimize the effects of unwanted film deposition by directing the process gas and byproducts into the exhaust system. One approach to reducing unwanted depositions uses purge gas to blanket critical areas, such as ceramic parts and the heater edge and backside. Another approach is to design the exhaust system to direct the flow of reactive gas away from critical areas. The exhaust flow may form “dead zones”, where little gas movement occurs. These dead zones approximate a purge gas blanket in that they displace reactive gases in that area and reduce unwanted depositions.

The present invention inhibits unwanted deposition on the pedestal and other parts of the chamber in other ways. Specifically, the present invention utilizes flow restrictor ring 46 to minimize gas flow beyond the pedestal to the bottom of the chamber. Flow restrictor ring 46 is supported by pedestal 32 during processing, as mentioned above. When the pedestal is lowered for wafer unloading and loading, the restrictor ring sits on ceramic ring 64 in ledge 69. As the pedestal supporting the next wafer is raised into processing position, it picks up the flow restrictor ring. At the pressures used in the chamber for the titanium processes according to embodiments of the invention, gravity is sufficient to hold both the wafer (disposed in the wafer pocket) and the restrictor ring on the pedestal.

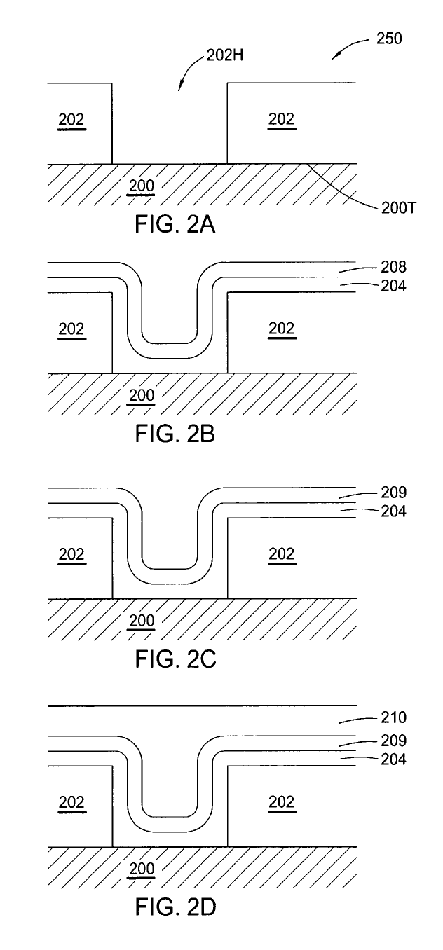

Prior to operation of the nitrogen-ambient thermal annealing process of the present invention, a refractory metal-boron layer is deposited onto the surface of a partially formed integrated circuit. The apparatus, method and conditions for depositing a refractory metal-boron layer are described in commonly assigned U.S. patent application Ser. No. 09/604,493, entitled “Formation of Boride Barrier Layers Using Chemisorption Techniques”, filed Jun. 27, 2000, which is incorporated herein by reference (Docket no. 4417). Referring to FIG. 2, a substrate 200 is shown. The substrate may be any workpiece upon which film processing is performed. Depending upon the stage of processing, the substrate 200 may be a silicon substrate, or other material layer which has been formed on a substrate surface. Substrate structure 250 is used generally to denote the substrate 200 as well as other material layers formed on the substrate 200. FIG. 2a, for example, shows a cross-sectional view of a substrate structure 250, with a silicon substrate having a material layer 202 deposited thereon. In accordance with one of the preferred embodiments of the present invention, layer 202 may be an oxide (e.g., silicon dioxide). The material layer 202 has been conventionally formed and patterned to provide a contact hole 202H extending to the top surface 200T of substrate 200. One skilled in the art will understand that the cross section and hole pattern shown in FIG. 2a is only one of numerous possible interconnect structures.

FIG. 2b shows a glue layer 204. In the present example, MO-TiN was conventionally deposited over the substrate structure 250 to aid in the adhesion of a refractory metal-boron layer 208 which was deposited by atomic layer deposition. Deposition of glue layer 204 is optional and the refractory metal-boron layer 208 may be applied directly over substrate structure 250.

FIG. 2c shows the substrate structure 250 following thermal annealing in ammonia at 700° C. There is no additional layer deposition. Rather, refractory metal-boron layer 208 has been modified such that it is now a nitrogen-rich refractory metal-boron layer 209.

FIG. 2d shows the substrate structure 250 following formation of a contact layer 210 formed over the nitrogen-rich refractory metal-boron layer 209. In the present example, contact layer 210 is preferably made of copper (Cu), otherwise referred to as copper metallization. Contact layer 210 may alternatively be from the group of aluminum (Al), tungsten (W), or combinations thereof. Contact layer 210 may be formed using electrochemical plating (ECP), physical vapor deposition (PVD), or a combination of both ECP and PVD. Contact layer 210 is preferably formed by copper seeding using PVD followed by ECP.

The nitrogen-rich refractory metal-boron layer 209 is formed by thermal annealing of the substrate structure 250 of FIG. 2b in a nitrogen containing ambient at temperatures ranging from 400° C. to 800° C. for a period of 10 seconds to 100 seconds. In the preferred embodiment, refractory metal boron layer 208 is formed by the atomic layer deposition technique using WF₆ and B₂H₆, resulting in an ALD-W layer. In the preferred embodiment, the nitrogen-containing gas is ammonia. The resulting layer 209 is ternary, W—B—N. It will be understood by one skilled in the art that other gas phase reactive nitrogen-containing compounds, such as hydrazine (N₂H₄), dimethyl hydrazine ((CH₃)₂N₂H₂), other derivatives of hydrazine and combinations thereof, may be used in place of ammonia. The W—B—N layer 209 produced by the process of the present invention remains amorphous following thermal annealing.

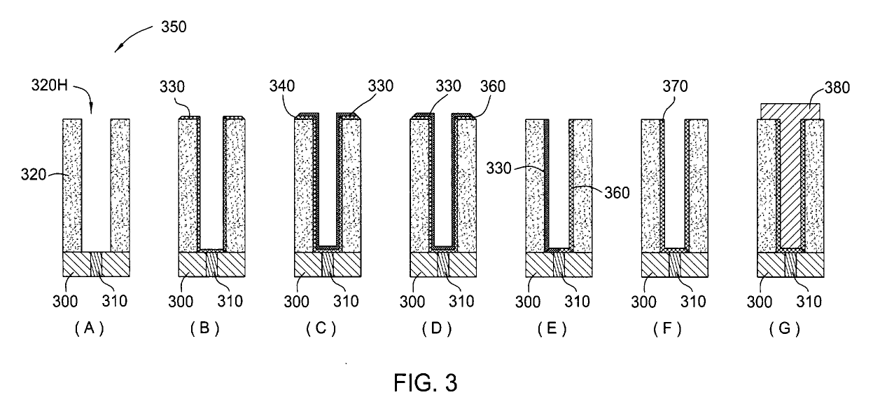

In another embodiment, the process of the present invention is used in the fabrication of an MIM capacitor. FIGS. 3a-3g illustrate schematically cross-sectional views of an integrated circuit during different stages of MIM capacitor fabrication. FIG. 3a illustrates a cross sectional view of a partially formed MIM structured capacitor. A silicon substrate 300 having a storage node 310 is coated with a silicon dioxide (SiO₂) material layer 320. Substrate structure 350 is used generally to denote the substrate 300 as well as other material layers formed on the substrate 300. The silicon dioxide material layer 320 has been conventionally formed and patterned to provide a contact hole 320H communicating with the top surface of storage node 310.

A glue layer 330, shown in FIG. 3b, is deposited by conventional chemical vapor deposition methods over the surface of the substrate structure 350. In the preferred embodiment, glue layer 330 is composed of MO-TiN. Glue layer 330 is used to promote the adhesion of the subsequent ALD-W layer and to ensure good electrical contact with the top surface of storage node 310. As shown in FIG. 3c, an ALD-W layer 340 is deposited over glue layer 330. ALD-W layer 340 is deposited by atomic layer deposition using WF₆ and B₂H₆. FIG. 3d illustrates the W—B—N layer 360 formed following nitrogen treatment of ALD-W layer 340 in accordance with the process of the present invention and as described in reference to FIGS. 1 and 2a through 2c.

As shown in FIG. 3e, the next step in the process of MIM capacitor fabrication is planarization of W-N-B layer 360 and glue layer 330 at the top of the structure by chemical-mechanical polishing. As shown in FIG. 3f, the substrate structure is coated with a high dielectric constant insulator layer 370 and the entire substrate structure is then subjected to the thermal treatments. In the preferred embodiment, high dielectric constant insulator layer 370 is Ta₂O₅ and the thermal treatments include: (1) annealing at about 700° C. for crystallization of the insulator layer; and (2) treatment in oxygen ambient at about 500° C. It will be understood by one of ordinary skill in the art that other high dielectric constant insulator materials, such as BST, may be used in lieu of Ta₂O₅ and that the thermal treatments may or may not be conducted in the presence of oxygen. As a final step in the fabrication of the MIM structured capacitor, an appropriate upper electrode material 380 is deposited by conventional means over the substrate structure 350. In the preferred embodiment, the upper electrode material 380 is titanium nitride (TiN) and is deposited by atomic layer deposition. It will be understood that other conventional conductive materials may be used as upper electrode material 380.

Embodiments of the present invention are further described in reference to the examples discussed below.

### EXAMPLE

Titanium nitride (TiN) deposited oxidized silicon substrates were used to generate the data for this example. The TiN layer was deposited by metal organic chemical vapor deposition using tetrakismethylamino titanium (TDMAT) precursor treated with plasma. A tungsten-boron film (ALD-W) was then deposited on each of the sample wafers using the ALD process using tungsten hexafluoride (WF₆) and diborane (B₂H₆) as precursors, using a 30 second anneal in ammonia ambient at a fixed chamber pressure of 10 Torr. Temperatures ranged from 400° C. to 700° C.

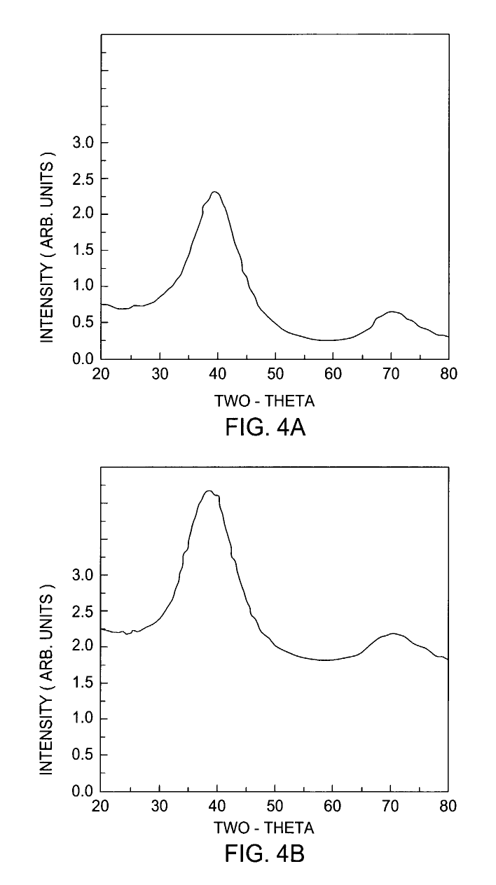

Structural changes were characterized by glancing angle x-ray diffraction using an incident angle of the x-ray source at 0.5 degrees with power for the x-ray source set at 45 kV and 40 mA. FIG. 4a shows an x-ray diffraction spectrum of the ALD-W film as deposited. The broad peaks indicate an amorphous structure. FIG. 4b shows an x-ray diffraction spectrum of the W—B—N layer that has been annealed at 700° C. for 30 seconds in an NH₃ ambient. The broad peaks indicate that the resulting W—B—N layer remains amorphous. Moreover, the spectra from films annealed at temperatures ranging from 400° C. to 600° C. have identical x-ray diffraction spectra (data not shown).

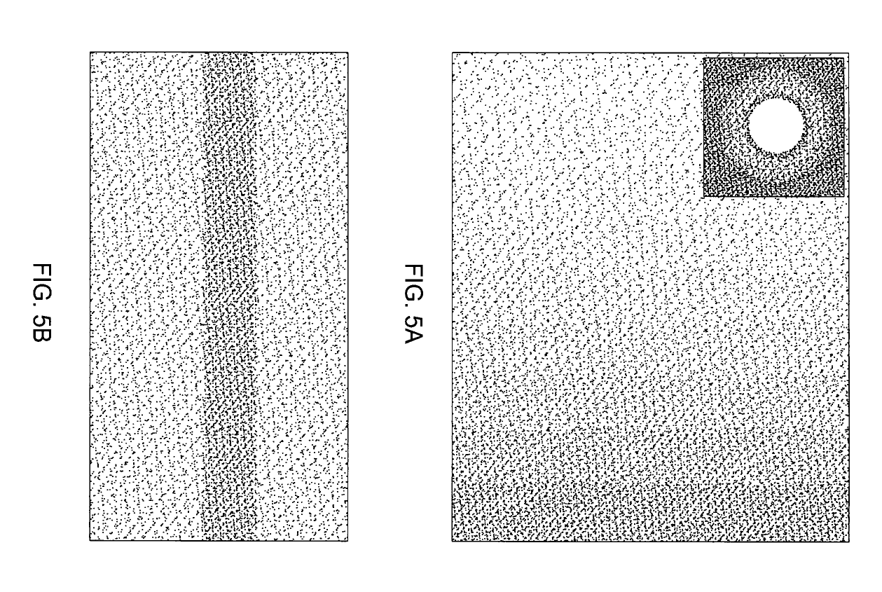

FIG. 5a is a plane-view transmission electron microscope image of the as-deposited film (x-ray diffraction spectra seen in FIG. 4a). The electron diffraction patterns exhibit only a few broad diffraction rings, indicating that the film has an amorphous structure. The transmission electron microscope image does not show a typical cluster boundary shown in amorphous films deposited by CVD techniques, suggesting that the mechanism for ALD film formation differs from that of CVD film formation.

FIG. 5b shows a cross-sectional view of a transmission electron microscope image of an ALD-W film that has been annealed at 700° C. There is no detectable crystallization of the film. Additionally, there is no interaction detected at the ALD-W/MOTin interface.

Sheet resistances (RSTotal) of 50 nm WBN films deposited on a TiN glue layer were measured by a four-point probe. In order to monitor the effect of temperature on the sheet resistance fo the WBN layer (Rs_{w}), the following calculation was made:

1/Rs_{w}=(1/RS_{Total})−(1/Rs_{TiN}).

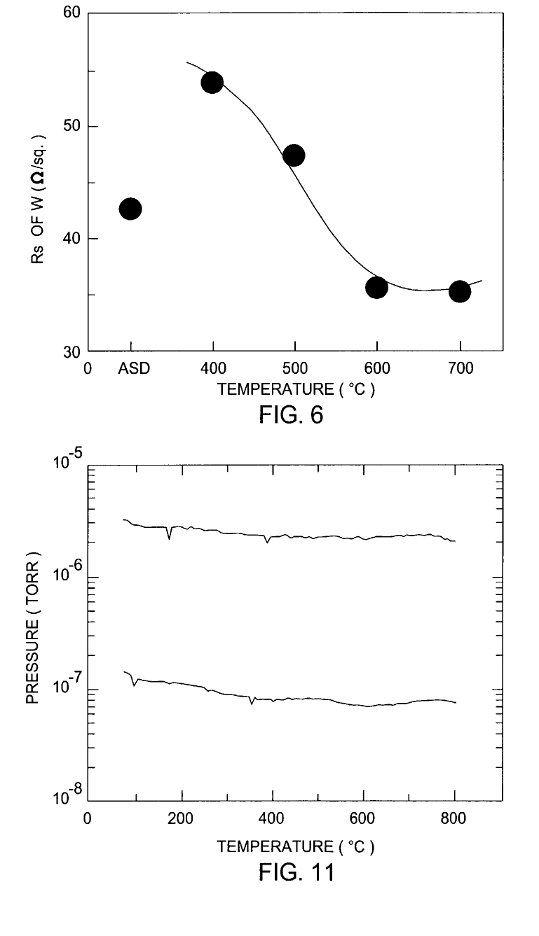

FIG. 6 illustrates the variation in sheet resistance of the 50 nm W—B—N films as a function of annealing temperature. The sheet resistance of the WBN film as deposited with no thermal treatment, referred to as ASD, is shown for comparison. An increase in sheet resistance is observed as between the ASD sample (about 42 Ω/sq) and the ammonia ambient 400° C. sample (about 54 Ω/sq). As annealing temperatures increase beyond 400° C., sheet resistance decreases, then levels for annealing temperatures greater than 600° C. (36 Ω/sq). The corresponding resistivities were determined to be 162, 142 and 107 ᵤΩ-cm at annealing temperatures of 400° C., 500° C., and >600° C., respectively, demonstrating that anneal temperatures affect film properties. The results illustrate also the existence of two temperature regimes that achieve different film structural characteristics: (1) annealing temperatures between 400° C. and 500° C.; and (2) annealing temperatures greater than 600° C.

The chemical status of the film surfaces were examined by x-ray photoelectron spectroscopy (XPS) using a monochromatic A1 Kα source and a concentric hemispherical electron energy analyzer. XPS depth profiling was used to determine the chemical bonding configuration, and the atomic concentrations and distributions as a function of depth within the films. To characterize the binding energy shifts, the XPS database maintained by the National Institute of Standards and Technology was used a reference. Because the samples are exposed to air after ammonia ambient annealing, XPS spectra were taken after every 5 or 10 seconds of Argon sputtering so that the effects of air exposure could be disregarded.

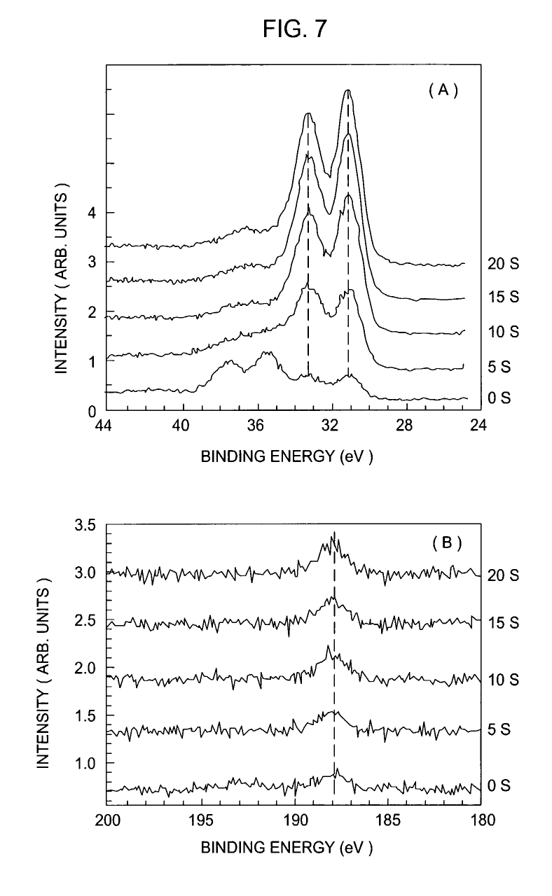

FIG. 7 shows the binding energy shifts of tungsten W_{4f} (a), and boron B₁ₛ (b) of an untreated, unannealed ALD-W film following argon sputtering with spectra taken at 5 second intervals from 0 seconds to 20 seconds. FIG. 7a illustrates the XPS binding energies associated with W_{4f}.

The 0 second signal exhibits four peaks at 31.2, 33.3, 35.6 and 37.7 eV, where the first two peaks represent W(4f_{7/2}) and W(4f_{5/2}) electrons for elemental tungsten in the zero oxidation state, and the latter two peaks correspond to those for a tungsten oxide. The tungsten oxide peaks disappear after 5 seconds of argon sputtering and the XPS spectra reveals binding energies identical to elemental tungsten with a weak satellite at 36.7 eV, which represents W(5_{p3/2}).

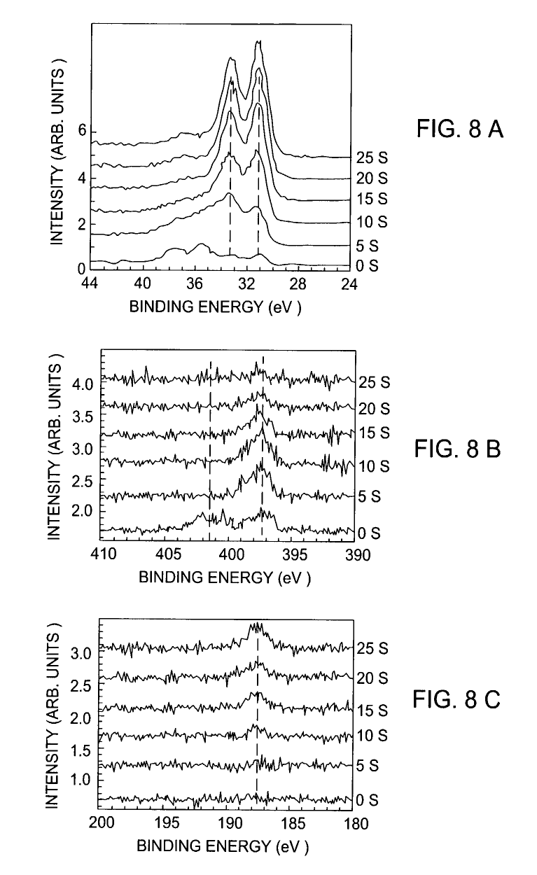

FIG. 7b shows the binding energy shifts of boron. At 0 seconds, a broad peak appears at 192.4 eV, which may indicate boron oxide (B₂O₃) at the film surface. The peak at 192.4 eV disappears after the first sputtering, however, and the signals in the 5 second and subsequent time points line up at 187.9 eV. This peak at 187.9 indicates that boron atoms exist in the film bound chemically to tungsten (as tungsten boride WBₓ), quantified to be at about 20 atomic percent (see FIG. 8a). XPS data on N₁ₛ (not shown) revealed a broad peak at 402 eV, which may have been due to nitrogen atoms incorporated into the tungsten oxide during exposure to air.

FIG. 8 shows the binding energy shifts of tungsten W_{4f}, nitrogen N₁ and boron B₁ₛ of an ALD-W film following annealing at 500° C. in an ammonia ambient for 60 seconds. XPS spectra was taken at 5 second intervals of argon sputtering from 0 seconds to 25 seconds. FIG. 8a indicates the existence of tungsten oxide at the surface of the film. The tungsten oxide disappears after the first 5 seconds of argon sputtering. FIG. 8b indicates a peak at 397.1 eV indicating the formation of tungsten nitride. FIG. 8c shows a peak at 187.9 eV indicating the presence of boron atoms bound to tungsten. In summary, the W—N—B film resulting from ammonia ambient annealing at 500° C. (within the lower temperature regime noted earlier) shows the nitrogen atoms preferentially binding to tungsten.

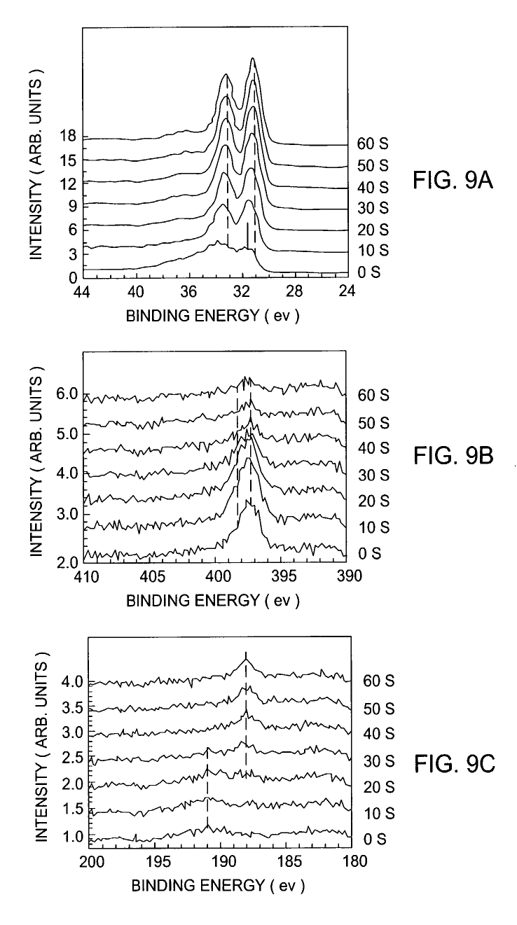

FIG. 9 shows the binding energy shifts of tungsten W_{4f}, nitrogen N₁ₛ and boron B₁ₛ of an ALD-W film following annealing at 700° C. in ammonia ambient for 60 seconds. XPS spectra was taken at 10 second intervals from 0 seconds to 60 seconds. FIG. 9a indicates the existence of a small amount of tungsten oxide at the surface of the film. The tungsten oxide disappears after the first 5 seconds of argon sputtering. FIG. 9a further shows a 0.5 eV shift to a higher binding energy in each of the W_{4f} peaks, indicating a charge transfer from tungsten to nitrogen. FIG. 9b does not indicate formation of a surface oxide, suggesting that a pre-existing oxide formed at the surface during air exposure is reduced during the higher temperature ammonia ambient anneal and that possibly further oxidation after the ammonia ambient anneal is prohibited by the presence of a surface nitride. FIG. 9b further shows both tungsten nitride and boron nitride peaks, with the tungsten nitride peak being the stronger of the two.

FIG. 9c shows the formation of boron nitride with a peak located at 190.7 eV. The boron nitride peak disappears however after about 30 seconds of argon sputtering, corresponding to a film depth of about 7.5 nm. Following 30 seconds of sputtering, the boron signal shows the presence of tungsten-boron bonds.

To investigate the thermal desorption behavior of any boron and/or nitrogen containing species, thermal desportion spectroscopy (TDS) analysis was performed on the 700° C. annealed sample. It was expected that the TDS signals of the boron-containing species would be close to those of nitrogen ions due to their similar atomic mass unit values. The atomic mass unit of boron-containing species, such as BH₃ (m/e=13.8) and B₂H₆ (m/e=27.6), are very close to those of single- and double-charged nitrogen ions, such as N₂⁺(m/e=28.0) and N₂²⁺(m/e=14.0). Therefore, if there are signals that appear due to the desorption of nitrogen, BH₃ or B₂H₆ would have to show a simultaneous signal. Note that neither BH₃ nor B₂H₆ (thus, N₂⁺ or N₂²⁺) show a signal (see FIG. 11).

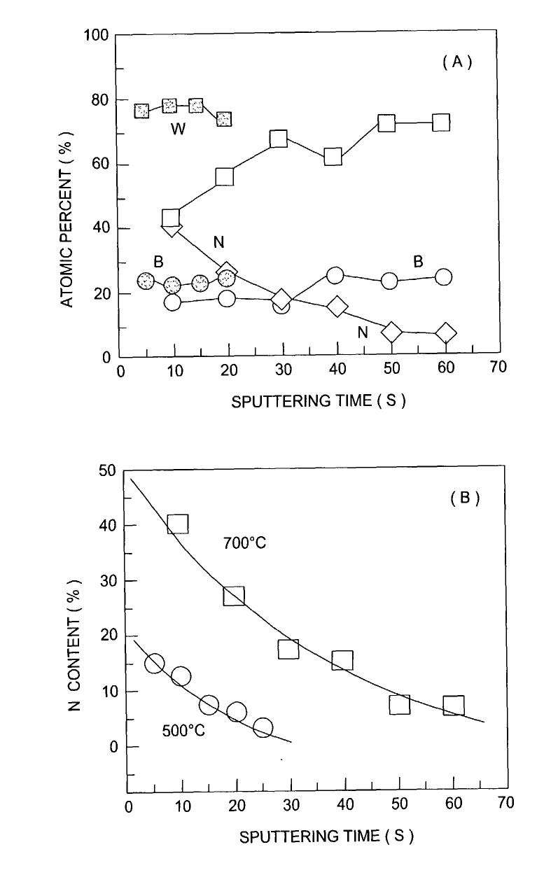

FIG. 10a shows the atomic distribution of tungsten, nitrogen and boron of the ALD-W film as a function of sputtering time before and after annealing in ammonia ambient at 700° C. for 60 seconds. Increased sputtering time corresponds with increased film depth. In FIG. 10a, the shaded data points show the atomic distribution for the untreated, unannealed ALD-W film, and the open squares, circles and triangles show the atomic distribution for the annealed ALD-W film. Note that initially a nitrogen-rich W—B—N layer is formed, where later a nitrogen-depleted layer is formed.

FIG. 10b compares the nitrogen content as a function of sputtering time for a film annealed at 500° C. in an ammonia ambient with a film annealed at 700° C. in an ammonia ambient. As the annealing temperature increases, the nitrogen atom diffusion depth and surface concentration increase.

The specific process conditions disclosed in the above discussion are meant for illustrative purposes only. Other combinations of process parameters such as substrate structure cross sectional profiles, temperatures, film thicknesses, and times may also be used in treating metal layers to form the nitrogen-containing metal layers described herein.

The description and teaching herein includes reference to and detailed description of certain preferred embodiments of the present invention, those skilled in the art may devise other embodiments which incorporate the teaching of the present invention.

While the foregoing is directed to embodiments of the present invention, other and further embodiments of the invention may be devised without departing from the basic scope thereof, and the scope thereof is determined by the claims that follow.

1. A process for formation of a nitrogen-containing refractory metal film comprising the steps of depositing a refractory metal-boron layer on the substrate; and
annealing a substrate in a nitrogen-containing atmosphere at a temperature of at least 400° C.

2. The process of claim 1 wherein said refractory metal-boron layer is deposited by atomic layer deposition.

3. The process of claim 1 wherein said refractory metal-boron layer comprises more than one refractory metals.

4. The process of claim 1 wherein the one or more refractory metal is selected from the group of tungsten (W), titanium (Ti), tantalum (Ta), molybdenum (Mo), zirconium (Zr), hafnium (Hf), cobalt (Co), ruthenium (Ru), platinum (Pt), iridium (Ir), palladium (Pd) or combinations thereof.

5. The process of claim 1 wherein said nitrogen-containing atmosphere comprises one or more gases from the group of ammonia, hydrazine, derivatives of hydrazine or nitrogen gas.

6. The process of claim 1 wherein said nitrogen-containing atmosphere comprises one or more gases from the group of ammonia, hydrazine, derivatives of hydrazine or nitrogen gas which has been activated by a plasma.

7. The process of claim 1 wherein the annealing step is performed at a temperature in a range from about 400° C. to about 500° C.

8. The process of claim 1 wherein the annealing step is performed at a temperature in a range from about 500° C. to about 800° C.

9. The process of claim 1 wherein the annealing step is performed for a time in a range of about 10 seconds to about 100 seconds.

10. A process for treating a substrate on which a tungsten-boron layer has been deposited comprising the step of annealing said substrate in the presence of ammonia ambient.

11. The process of claim 10 wherein the annealing step occurs at an ambient temperature between about 400° C. and about 500° C.

12. The process of claim 10 wherein the annealing step occurs at an ambient temperature between about 500° C. and about 800° C.

13. A process for forming a device, comprising the steps of:
depositing a refractory metal-boron layer on a substrate having a dielectric layer thereon, wherein the dielectric layer has one or more via holes therein; and
annealing the substrate in a reactive nitrogen-containing gas.

14. The process for forming a device of claim 20 further comprising the step of depositing a conductive layer on the substrate, wherein the conductive layer fills said via holes.

15. The process of claim 13 wherein the refractory metal-boron layer is tungsten boride.

16. The process of claim 13 wherein the reactive nitrogen-containing gas is ammonia.

17. The process of claim 14 wherein the conductive layer is copper.

18. A process for fabrication of a MIM structured capacitor comprising the steps of:
depositing a refractory metal-boron layer on a substrate having a dielectric layer thereon and having a storage node communicating through a portion of said substrate, wherein the dielectric layer has a via hole therein and wherein a top surface of said storage node communicates with said via hole; and
annealing said substrate in a reactive nitrogen-containing gas.

19. The process for fabrication of a MIM structured capacitor of claim 18 further comprising the step of depositing a high dielectric constant insulator on the substrate.

20. The process for fabrication of a MIM structured capacitor of claim 19 further comprising the step of depositing an upper electrode layer on said substrate, said upper electrode layer filling said via holes.

21. The process of claim 18 wherein the refractory metal-boron layer is tungsten boride.

22. The process of claim 18 wherein the reactive nitrogen-containing gas is ammonia.

23. The process of claim 26 wherein said high dielectric constant insulator is tantalum dioxide.

24. The process of claim 20 wherein said upper electrode layer is titanium nitride.

25. An interconnect device comprising:
(a) a substrate having a dielectric layer thereon, wherein the dielectric layer has one or more via holes therein;
(b) a refractory metal-nitrogen-boron layer deposited on said substrate; and
(c) a conductive layer on said substrate overlying said refractory metal-nitrogen-boron layer and wherein said conductive layer fills said via holes.

26. The interconnect device of claim 25 wherein said refractory metal-nitrogen-boron layer is tungsten-nitrogen-boron.

27. The interconnect device of claim 25 wherein said conductive layer is copper.

28. A MIM structured capacitor comprising:
(a) a substrate having a dielectric layer thereon and having a storage node communicating through a portion of the substrate, wherein the dielectric layer has a via hole therein and wherein a top surface of the storage node communicates with the via hole;
(b) a refractory metal-nitrogen-boron layer deposited on the substrate;
(c) a high dielectric constant insulator layer deposited on the substrate overlying the refractory metal-nitrogen-boron layer; and
(d) an upper electrode layer on said substrate overlying the refractory metal-nitrogen-boron layer, the upper electrode layer filling said via holes.

29. The MIM structured capacitor of claim 28 wherein the substrate is silicon.

30. The MIM structured capacitor of claim 28 wherein the dielectric layer is silicon dioxide.

31. The MIM structured capacitor of claim 28 wherein the high dielectric constant insulator layer is tantalum dioxide.

32. The MIM structured capacitor of claim 28 wherein the upper electrode layer is titanium nitride.

33. A barrier film for use in the fabrication of wafers comprising:
a ternary phase comprising tungsten nitride and tungsten boride.

34. The barrier film of claim 33 wherein the atomic percentage of nitrogen is between about 2.5% and about 15%.

35. The barrier of film of claim 40 wherein the atomic percentage of boron is about 20%.

36. A barrier film for use in the fabrication of wafer comprising:
a surface layer comprising tungsten nitride and boron nitride; and
a lower layer comprising tungsten boride and tungsten nitride.

37. The barrier film of claim 36 wherein said surface layer is about 7.5 nm thick.

38. The barrier film of claim 36 wherein the atomic percentage of nitrogen in said surface layer is between about 40% and 18%.

39. The barrier film of claim 36 wherein the atomic percentage of nitrogen in said lower layer is between about 5% and 18%.

40. The barrier film of claim 36 wherein the atomic percentage of boron in said surface layer is between about 10% and 20%.

41. The barrier film of claim 36 wherein the atomic percentage of boron is said lower layer is between about 20% and 25%.

42. A barrier film for use in the fabrication of wafer comprising:
a surface layer consisting essentially of tungsten, boron and nitrogen; and
a lower layer consisting essentially of tungsten, boron and nitrogen.

43. The barrier film of claim 42 wherein said surface layer is about 7.5 nm thick.

44. The barrier film of claim 42 wherein the atomic percentage of nitrogen in said surface layer is between about 40% and 18%.

45. The barrier film of claim 42 wherein the atomic percentage of nitrogen in said lower layer is between about 5% and 18%.

46. The barrier film of claim 42 wherein the atomic percentage of boron in said surface layer is between about 10% and 20%.

47. The barrier film of claim 42 wherein the atomic percentage of boron is said lower layer is between about 20% and 25%.

48. A barrier film for use in the fabrication of wafers comprising:
a ternary phase consisting essentially of tungsten, nitrogen, and boron.

49. The barrier film of claim 48 wherein the atomic percentage of nitrogen is between about 2.5% and about 15%.

50. The barrier of film of claim 48 wherein the atomic percentage of boron is about 20%.
